(19) United States
(12) Patent Application Publication
(10) Pub. No.: US 2008/0188208 A1
(43) Pub. Date: Aug. 7, 2008

(54) Volume control process of a mobile device

(75) Inventor: Chien-Fu Sung, Sanchong City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 12/003,939

(22) Filed: Jan. 3, 2008

(30) Foreign Application Priority Data
Feb. 7, 2007 (TW) 096104510

(51) Int. Cl. H04M 3/00; H04M 1/00; H04M 3/42

(52) U.S. Cl. 455/414.1; 379/388.01; 455/418

(57) ABSTRACT

The present invention discloses a volume control process of a mobile device to resolve issue of using the same volume between the speech state and the ring state in a traditional mobile device. Speaker volume output of the mobile device in the ring state and the speech state is set by a ring volume mode and a speech volume mode, respectively.

### FIELD OF INVENTION

The present invention relates to a volume control process of a mobile device, particularly to a method that is capable of setting call volume or ring volume (mode) of a speaker output of a mobile device in various modes.

### BACKGROUND OF INVENTION

Recently, mobile communication device such as mobile phone, Personal Digital Assistant, smart phone, personal computer and notebook computer, or tablet PC, web PDA etc. are widely used. Development of the mobile communication device has distributed into two field including cellular phone and portable data processing device. Due to the explosion of growth in the mobile commerce, there is a tendency towards integrating the function of the above-mentioned two types. For example, it is made for smart phone with powerful performance of data processing, or PDA cellular phone based-on PDA architecture, which are integrated by communication function of the cellular phone and data processing function of the computer and internet.

In general, a mobile communication device has a main function of making a call, which includes many operational modes and database. The operational modes includes many settings, for example volume value, in silent, call switch, vibrating mode . . . etc., and the database stores and records some data, for instance communication lists. When the mobile phone is turn on, the phone starts in an idle state. The mobile phone in the idle state may be turn off to interrupt the function of the mobile phone.

Presently, ring volume and speech volume of a mobile device are output with the same volume, which the output volume of the mobile device has a constant value. Therefore, when a user in call has a notification during call from a remote side, the louder ring volume will interfere the call processing.

Based-on the prior art, the constant value of the ring volume and speech volume causes louder ring volume to interfere the call processing. The present invention provides a new volume control process of a mobile device to resolve the above issues.

### SUMMARY OF THE INVENTION

Due to the above-mentioned prior art, ring volume and speech volume of a mobile communication device are output with the same volume, wherein the output volume of the mobile device has a constant value. The present invention provides a volume control process of a mobile device, wherein the output volume of the ring volume and speech volume of the mobile device has a different value. Relation of the ring volume value and speech volume value may refer to a correspondent look-up table.

Purpose of this invention is to provide a solution of the issue that the call quality of a mobile device suffers from louder ring volume during call, which is employed by auto-switching output volume (mode) of the mobile device from ring volume mode to speech volume mode in the state of during call, notification during call or idle, and thereby outputting different corresponding ring volume and speech volume.

Another aspect of the present invention is utilized a state machine (state-driven) for fully controlling the ring volume value and speaker volume value of a mobile communication device (for example telephone, mobile phone), which will avoid the ring tone (volume) is too loud during a call session if the mobile communication device has one audio device embedded only.

The present invention is provided a volume control process of a mobile communication device, comprising: firstly, setting output volume as a ring volume mode in idle state; and then keeping output volume as the ring volume mode when the idle state is transferred into a ringing state; next, switching the ring volume mode into a first speech volume mode when the ringing state is transferred into a during call state; and finally, switching the ring volume mode into a second speech volume mode when entering a notification during call state.

The mobile communication device comprises a speaker, wherein output volume of the speaker comprises a ring volume and speech volume, and output volume of the speaker is set by the ring volume mode and the first and second speech volume mode to create different ring output volume values and speech output volume values in the idle state, ringing state, during call state and notification during call state.

The ring volume mode is set as different ring output volume values and speech output volume values of a speaker. The first and second speech volume mode is set as different ring output volume values and speech output volume values of a speaker.

Output volume of a speaker of the idle state is more than that of the during call state. Volume control process of a mobile device of the present invention further comprises a look-up table referring to correspondent relation of the ring volume value and speech volume value. The idle state transferring into a ringing state is over through a ring play.

### BRIEF DESCRIPTION OF THE DRAWING

For a better understanding of the present invention and to show how it may be implemented, reference will now be made to the following drawings:

FIG. 1 is a block diagram showing process flow of states transition of a mobile communication device of the present invention.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments. In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention.

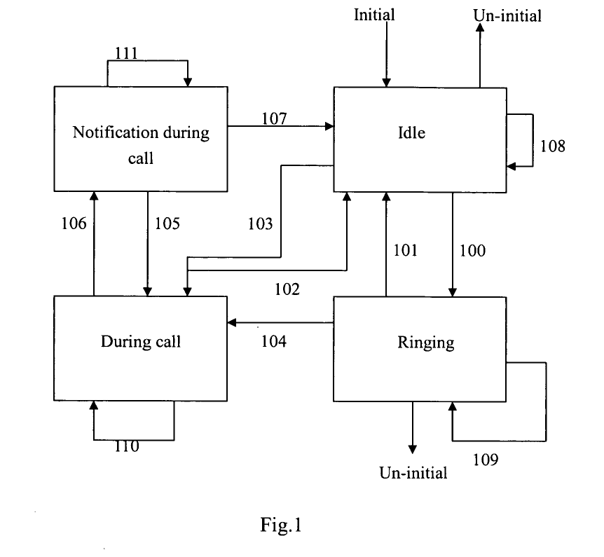

Referring to FIG. 1, the diagram is used for illustrating and not used for limiting the scope of the present invention. In FIG. 1, it shows a block diagram showing process flow of states transition with a volume control of a mobile communication device of the present invention. Audio device of the present invention can be applied to a mobile communication device and not limiting the mobile communication device, others electrical devices with call function may be applied. The mobile communication device of the present invention may switch or change the volume control mode as various states transition.

The mobile communication device is power on to be activated as idle state. In idle state, output volume of a speaker of the present invention is set as a ring volume mode, which output volume of the mobile communication device is in a ring stop 108. Moreover, the mobile communication device may be power off to shutdown it.

When the mobile communication device receives a call request signal from another device to activate its speaker by a ring play module, the idle state may be transferred into a ringing state which output volume of the speaker is maintained as the ring volume mode.

In the ringing process or state, user may select to adapt an answer call 104 for response or keep a period of time ringing and go through a ring stop 101 back to the idle state.

When the device is performed a call request, the user starts to answer a phone call which the mobile communication device is in a during call state. The mobile communication device will automatically switch from ring volume mode into a first speech volume mode which the mobile communication device is still in a ring stop 110 state, wherein the mode switching of the mobile communication device is performed by a logic circuit, which may be a state machine.

Moreover, the mobile communication device of the present invention may implant a volume control look-up table for conveniently controlling volume which comprises correspondent relation of the ring volume value and speech volume value, and comprises many various sets of combinations of ring volume value and speech volume value. The mobile communication device may be adjusted output volume of a speaker according to the look-up table. Besides, between of the ring volume value and speech volume value of the first speech volume mode has a correspondent relation. User may set relation of the ring volume value and speech volume value of the mobile communication device in various situations.

In the during call process or state, output volume of the ring volume mode is more than that of the first speech volume mode, and therefore user may answer a phone call under a suitable volume. In other words, in the speech volume mode, ring volume value and speech volume value of the mobile communication device may be controlled respectively.

In general, ringing volume of the ringing state is far larger than that of the speech state to notify a user that a mobile communication device has received a call request from another device in a ringing state. Ringing volume of the mobile communication device may be amplified enough to clearly notify the user that a mobile communication device has received a call request signal. In the prior art, when a mobile phone is switching from a ringing state to speech state, it always plays the ring tone or notification with ring volume and plays ring tone and speech with the same volume.

In the present invention, when a mobile communication device is transferring from a ringing state to speech state, the output volume mode of a speaker is switching from ring volume mode to speech volume mode, and plays ring tone and speech with the different output volume which is obviously different from the above-mentioned prior art.

In other words, in a during call process or state, ring tone and speech of the present invention are not using the same volume like of the prior art, and therefore user may suitably answer a phone call. When user ends the call, the mobile communication device goes through a ring stop 102 back to the idle state.

Moreover, in the during call process or state, the mobile communication device receives a call request signal from a third party device, and then the mobile communication device adds a notification during call except the present during call. The user may be informed by a ring play 106 process of the mobile communication device. In one embodiment, the notification during call state comprises many different process or state, for example, remote side busy notification, remote side voice mail answer notification, remote side voice mail answer end and call waiting notification. In the present invention, output volume mode of a speaker is switching from ring volume mode into a second speech volume mode when entering a notification during call state, wherein the mode switching of the mobile communication device is performed by a logic circuit, which may be a state machine.

From above-mentioned, the present invention provides a second look-up table specifying correspondent relation of the ring volume value and speech volume value of the mobile device. In other words, between of the ring volume value and speech volume value of the second speech volume mode has a correspondent relation. User may set relation of the ring volume value and speech volume value of the speaker. For example, the second speech volume mode may be set various ring volume value and speech volume value output.

When the mobile device receives a notification during call request, a user may select to adapt the notification during call state for response and entering the state or keep a period of time ringing and go through a ring stop 105 ending the notification during call state which user could continue the original call. In the present invention, output volume mode of the speaker is set as the second speech volume mode which ring volume may be set various values, for example smaller (for normal user) or larger (for deaf user) depending on various situations.

When the notification during call state of the mobile device is performed, the user makes a speech to another one which is a notifier. In the notification during call state, output volume of a speaker may be set as an adjustable speech volume mode, and ring volume output of the speaker is in a ring play 111 state. In the present invention, output volume mode of the speaker may be set as the speech volume mode which speech volume may be set various value depending on various situations, and therefore the speech volume of the notification during call state is the same as that of the original during call state. Thus, the ring volume and speech volume may be adjusted as various values with various situations. Accordingly, ring volume of the notification during call state may be set as smaller output volume such that the user in call has a good call quality and would not suffer from louder ring volume.

When the notification during call state is over, the mobile communication device goes through a stop call 107 back to the idle state.

Moreover, when the mobile communication device is in an idle state, if the mobile communication device is set as a silent state or mode, when the mobile communication device receives a call request signal from another device, the mobile communication device may notify the user by means of activating vibrator on or light on the device, that the mobile communication device has received the call request signal. When the mobile device receives a during call request from a remote side in a silent state, a user may select to answer the call 103 for response or keep a period of time activating vibrator on until the mobile device is back to the idle state. When entering the call 103, the user could start the call which the mobile communication device is in during call state. The output volume of the mobile communication device will be automatically switched as a first speech volume mode. When the user ends the call, the mobile communication device goes through a stop call 102 and then back to the idle state.

From above-mentioned, in the present invention, usage states of the mobile communication device comprise an idle state, a ringing state, a during call state and notification during call state. In the idle state and the ringing state, output volume mode of a speaker is set as a ring volume mode. In the notification during call state and during call state, output volume mode of a speaker is set as an adjustable speech volume mode. The user may set a correspondent volume control look-up table referring to the ring volume value and speech volume value such that the mobile communication device may be adjusted output volume of the ring volume value and speech volume value according to the look-up table.

By contrast with the prior art, the ring volume (tone) and speech volume is the same volume, the present invention provides a new scheme to satisfy the user for comfortable listening smaller ring volume in the notification during call state.

Therefore, the present invention may utilize the software phone and the adapter for communication between the mobile phone, telephone and the software phone. Further, the communication cost can be reduced by the present invention. The system may achieve dual modes including telephone and software phone via PSTN and internet, respectively. It will not change the operation custom of the user.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A process of volume control of an audio device, comprising:
performing a output volume of a ring volume mode when an idle state is transferred into a ringing state;
changing the output volume by switching said ring volume mode into a first speech volume mode when said ringing state is transferred into a during call state; and
changing the output volume by switching said ring volume mode into a second speech volume mode when entering a notification during call state.

2. The process as set forth in claim 1, wherein said audio device comprises a speaker, output volume of said speaker comprises a ring volume and speech volume, said output volume of said speaker is set by said ring volume mode and said first and second speech volume mode to create different ring output volume values and speech output volume values in said idle state, said ringing state, said during call state and said notification during call state.

3. The process as set forth in claim 1, wherein said output volume of said ring volume mode is more than that of said first and second speech volume mode.

4. The process as set forth in claim 1, wherein said transferring of the idle state into the ringing state is over through a ring play.

5. The process as set forth in claim 1, wherein said notification during call state comprises remote side busy notification, remote side voice mail answer notification, remote side voice mail answer end and call waiting notification.

6. The process as set forth in claim 1, wherein said ring volume mode is set as various ring output volume values of a speaker.

7. The process as set forth in claim 1, wherein said first and second speech volume mode is set as various speech output volume values of a speaker.

8. The process as set forth in claim 1, wherein output volume of a speaker of said idle state is more than that of said during call state.

9. A process of volume control of an audio device, comprising:
performing a call request notification of a silent mode when an idle state is transferred into a ringing state;
changing the output volume by switching said silent mode into a first speech volume mode when said ringing state is transferred into a during call state; and
changing the output volume by switching said silent mode into a second speech volume mode when entering a notification during call state.

10. The process as set forth in claim 9, wherein said audio device comprises a speaker, the output volume of said speaker comprises said first and second speech volume mode to create different speech output volume values in said idle state, said ringing state, said during call state and said notification during call state.

11. The process as set forth in claim 9, wherein said notification during call state comprises remote side busy notification, remote side voice mail answer notification, remote side voice mail answer end and call waiting notification.

12. The process as set forth in claim 9, when said call request notification comprises vibrator activated on or light on.

13. The process as set forth in claim 9, wherein said first and second speech volume mode is set as different speech output volume values of a speaker.
